(19) United States
(12) Patent Application Publication
(10) Pub. No.: US 2003/0206109 A1
(43) Pub. Date: Nov. 6, 2003

(54) Detection device for detecting existence of urine or excrement in a diaper

(76) Inventor: Hong Yuan Yang, Changhua (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/137,307

(22) Filed: May 3, 2002

(51) Int. Cl. G08B 23/00

(52) U.S. Cl. 340/573.5; 340/539.11

(57) ABSTRACT

A detection device for detecting existence of urine or excrement in a diaper includes a sensor mounted on a diaper, and a receiver mounted on a care-taker. When the sensing line of the sensor detects that the variation of moisture of the diaper exceeds a determined value during a period time, the sensor may emit a wireless signal that may be received by the receiver mounted on the body of the care-taker. At the same time, the wireless signal received by the receiver may be converted into a warning signal in the form of sound or vibration, so as to inform the care-taker to replace the diaper.

### BACKGROUND OF THE INVENTION

1. Field of the Invention

The present invention relates to a detection device for detecting existence of urine or excrement in a diaper, and more particularly to a detection device for detecting existence of urine or excrement in a diaper, wherein the detection device may instantly inform the care-taker to manage or replace the diaper, thereby preventing the diaper from being covered by urine or excrement during a long time.

2. Description of the Related Art

A conventional diaper is available for users, such as babies, old people, handicapped people or the like. However, when the urine or excrement produced by the user is deposited in the diaper during a period of time, the user will feel very uncomfortable, so that the diaper needs to be replaced after being used during a period of time. Thus, the care-taker needs to frequently detach the diaper to inspect if the diaper is wetted or dirtied by the urine or excrement produced by the user, thereby easily disturbing or waking the user.

### SUMMARY OF THE INVENTION

The primary objective of the present invention is to provide a detection device for detecting existence of urine or excrement in a diaper, wherein the detection device may instantly inform the care-taker to manage or replace the diaper, thereby preventing the diaper from being covered by urine or excrement during a long time.

Another objective of the present invention is to provide a detection device for detecting existence of urine or excrement in a diaper, wherein the detection device may inform the care-taker in a vibration manner, thereby preventing disturbing or waking the user.

A further objective of the present invention is to provide a detection device for detecting existence of urine or excrement in a diaper, wherein the sensing line of the sensor may be replaced, thereby keeping sanitation.

In accordance with the present invention, there is provided a detection device for detecting existence of urine or excrement in a diaper, comprising:

a sensor, mounted on a diaper, and including a sensing line mounted in the diaper, to detect variation of moisture of the diaper, so that the sensor may emit a wireless signal; and

a receiver, mounted on a care-taker, for receiving the wireless signal emitted from the sensor, and for emitting a warning signal.

Preferably, the sensor is clipped on a top of the diaper.

Preferably, the sensing line of the sensor is extended to a crotch of the diaper.

Preferably, the sensing line of the sensor is replaceable.

Preferably, the receiver may emit the warning signal in a form of sound.

Preferably, the receiver may emit the warning signal in a form of vibration.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a detection device for detecting existence of urine or excrement in a diaper in accordance with a preferred embodiment of the present invention;

FIG. 2 is a partially cut-away enlarged view of the detection device for detecting existence of urine or excrement in a diaper as shown in FIG. 1;

FIG. 3 is a flow chart of the detection device for detecting existence of urine or excrement in a diaper in accordance with the preferred embodiment of the present invention;

FIG. 4 is a schematic operational view of the detection device for detecting existence of urine or excrement in a diaper as shown in FIG. 1 in use; and

FIG. 5 is a schematic operational view of the detection device for detecting existence of urine or excrement in a diaper as shown in FIG. 1 in use.

### DETAILED DESCRIPTION OF THE INVENTION

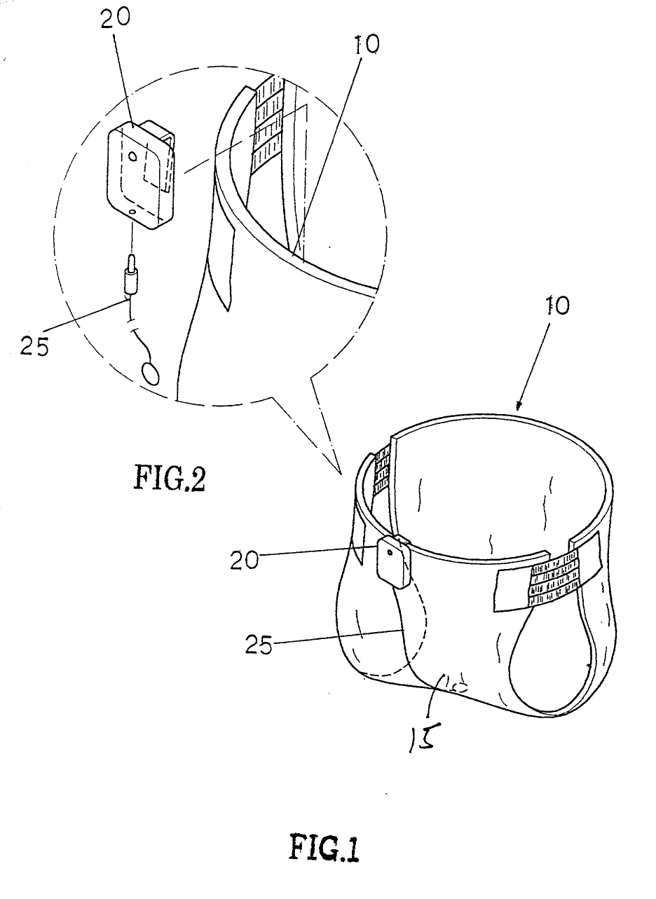

Referring to the drawings and initially to FIGS. 1 and 2, a detection device in accordance with a preferred embodiment of the present invention may be used for detecting existence of urine or excrement in a diaper, so that the diaper wetted or dirtied by the urine or excrement may be managed or replaced instantly.

The detection device in accordance with the preferred embodiment of the present invention comprises a sensor 20 mounted on a diaper 10, and a receiver 30 (see FIG. 5) mounted on a care-taker 40 (see FIG. 5).

The sensor 20 includes a replaceable sensing line 25 mounted in the diaper 10. Preferably, the sensor 20 may be clipped on the top 11 of the diaper 10, and the sensing line 25 may be extended to the crotch 15 of the diaper 10. The sensing line 25 may co-operate with the sensor 20 to detect variation of moisture of the diaper 10 sensitively. For example, if the variation of moisture of the diaper 10 exceeds a determined value during a period time, the sensor 20 may emit a wireless signal.

The receiver 30 is corresponding mounted on the body of the care-taker 40. The receiver 30 may receive the wireless signal emitted from the sensor 20, and may simultaneously emit a warning signal by sound or vibration, so as to inform the care-taker 40 to manage or replace the diaper 10.

By the above-mentioned design and arrangement, the detection device in accordance with the preferred embodiment of the present invention may detect existence of urine or excrement in the diaper 10 and may inform the care-taker 40 synchronously, so that the diaper 10 wetted or dirtied by the urine or excrement may be managed or replaced instantly.

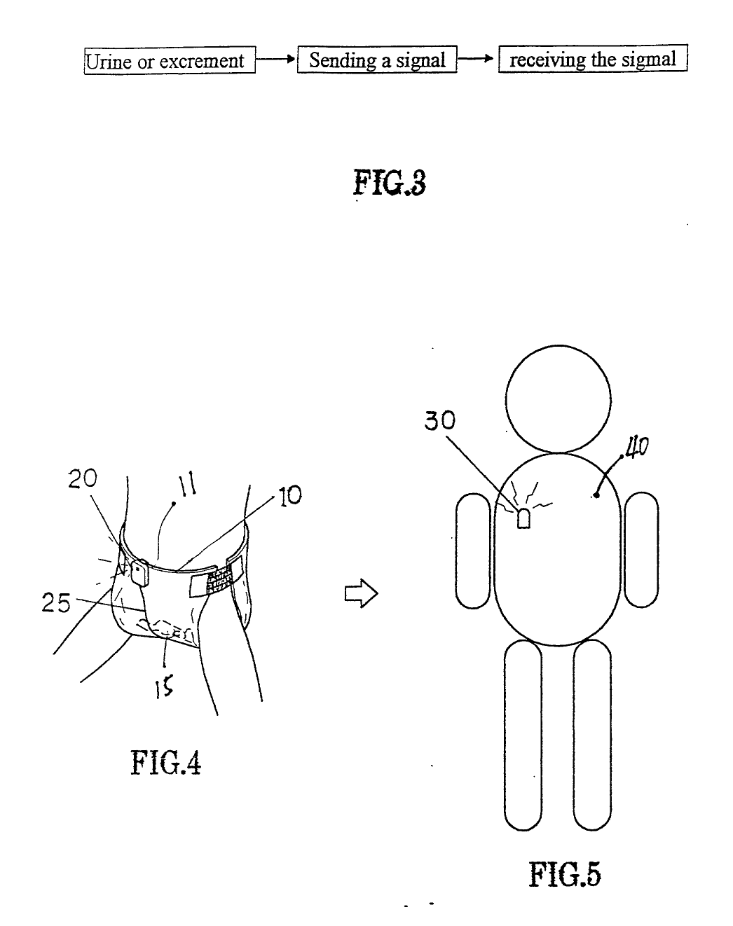

In practice, referring to FIGS. 3-5 with reference to FIGS. 1 and 2, the urine or excrement produced by the user will wet the diaper 10. At this time, after the sensing line 25 of the sensor 20 detects that the variation of moisture of the diaper 10 exceeds a determined value during a period time, the sensor 20 may emit a wireless signal that may be received by the receiver 30 mounted on the body of the care-taker 40. At the same time, the wireless signal received by the receiver 30 may be converted into a warning signal in the form of sound or vibration, so as to inform the care-taker 40 to manage or replace the diaper 10, thereby preventing the diaper 10 from being covered by urine or excrement too long.

Thus, the detection device may instantly inform the care-taker 40 to manage or replace the diaper 10, thereby preventing the diaper 10 from being covered by urine or excrement during a long time. In addition, the detection device may inform the care-taker 40 in a vibration manner, thereby preventing disturbing or waking the user. Further, the sensing line 25 of the sensor 20 may be replaced, thereby keeping sanitation.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A detection device for detecting existence of urine or excrement in a diaper, comprising:
a sensor, mounted on a diaper, and including a sensing line mounted in the diaper, to detect variation of moisture of the diaper, so that the sensor may emit a wireless signal; and
a receiver, mounted on a care-taker, for receiving the wireless signal emitted from the sensor, and for emitting a warning signal.

2. The detection device for detecting existence of urine or excrement in a diaper in accordance with claim 1, wherein the sensor is clipped on a top of the diaper.

3. The detection device for detecting existence of urine or excrement in a diaper in accordance with claim 1, wherein the sensing line of the sensor is extended to a crotch of the diaper.

4. The detection device for detecting existence of urine or excrement in a diaper in accordance with claim 1, wherein the sensing line of the sensor is replaceable.

5. The detection device for detecting existence of urine or excrement in a diaper in accordance with claim 1, wherein the receiver may emit the warning signal in a form of sound.

6. The detection device for detecting existence of urine or excrement in a diaper in accordance with claim 1, wherein the receiver may emit the warning signal in a form of vibration.
